(19) United States
(12) Patent Application Publication
(10) Pub. No.: US 2023/0413393 A1
(43) Pub. Date: Dec. 21, 2023

(54) INDUCTION COOKTOP WITH INFRARED AND FAR-INFRARED TEMPERATURE DETECTION

(71) Applicant: WHIRLPOOL CORPORATION, Benton Harbor, MI (US)

(72) Inventors: Alan P. Nguyen, St. Joseph, MI (US); Collin Andrew Stipe, St. Joseph, MI (US)

(73) Assignee: WHIRLPOOL CORPORATION, BENTON HARBOR, MI (US)

(21) Appl. No.: 17/843,109

(22) Filed: Jun. 17, 2022

(51) Int. Cl. H05B 6/06; H05B 6/64

(52) U.S. Cl. CPC H05B 6/062; H05B 6/6455; H05B 2213/06

(57) ABSTRACT

An induction cooktop includes a glass-ceramic substrate defining a cooking surface and an underside opposite the cooking surface and an induction heating coil positioned beneath the underside of the cooking surface. The induction cooktop further includes an infrared sensor directed toward the underside of the glass-ceramic substrate and outputting a first temperature reading of the glass-ceramic substrate during heating of a cooking article positioned on the cooking surface using the induction heating coil and a far-infrared sensor directed through the glass-ceramic substrate and outputting a second temperature reading of the cooking article and the glass-ceramic substrate. A controller determines a temperature of the cooking article using the first temperature reading from the infrared sensor and the second temperature reading from the far-infrared sensor.

### BACKGROUND OF THE DISCLOSURE

The present disclosure generally relates to an induction cooktop, and more specifically, to an induction cooktop that uses a combination of infrared and far-infrared sensors to determine the temperature of a cooking article being heated.

Induction cooktops, in general, lack an actual heat source, instead using induction to generate eddy currents within a cooking article to cause internal heating of the cooking article material. This may make such cooking appliances useable with temperature sensors to measure the actual heating effect achieved by the use of one or more of the inductive heating coils in connection with cooking articles. Further, the precise and responsive control of heating using an induction cooktop makes it theoretically possible to achieve a desired temperature in a cooking article, including by initial high levels of heating to decrease the time needed to reach a selected temperature. Most temperature detection devices currently used with induction cooktops, however, have various limitations. In one example, a pop-up sensor can be used below the cooking article to measure the bottom surface temperature of the pan. The sensor can be spring-loaded to maintain contact with the bottom of the cooking article. Pop-up sensors, however, require a hole in the glass of the cooktop and prevent the surface of the cooktop from being completely smooth, which can lead to cleaning and manufacturing issues related to stack-up and assembly of the unit. Pop-up sensors are also visible, reduce the useable area on the cooktop surface, and can result in undesirable collisions between the sensors and objects. A side infrared sensor can be placed above the ceramic glass to measure directly the cooking article temperature from the side. Depending on the height of the cooking article and the line of sight of the sensor, there can be inaccurate temperature measurements compared to the true temperature at the bottom and/or top surface of the cooking article. A temperature sensor can be embedded in a cooking article to measure temperature. The cooking article can then be connected directly to the cooktop, phone, tablet, or other device. The cooking article can also be connected wirelessly by NFC, WiFi, Bluetooth or other wireless communication methods or protocols. Such a configuration, however, requires the consumer to buy a specific cooking article for use on the cooktop. Similarly, wireless sensors can be connected directly to the cooking article to measure the cooking article temperature from a surface location thereof. Wired accessories can be connected to the stovetop, tablets, phones, etc. Wireless accessories can be connected to stovetop software and/or applications via Bluetooth, WiFi, radio frequency, etc. Drawbacks include increased number of consumer interactions during the cooking process (attaching/detaching, cleaning), increased number of components involved with stovetops, and self-heating via induction through the conductive materials.

Some current induction cooktops use negative temperature coefficient (“NTC”) thermistors to read the temperature of the glass-ceramic substrate. These measurements, significantly, do not represent the temperature of the bottom surface of the cooking article, as the glass-ceramic temperature increases due to heat dissipation from the cooking article. The slow dissipation of heat is represented in the temperature measurement from the NTC and introduces attenuation and time delays between the temperature of the glass-ceramic and the temperature of the cooking article. Air gaps between the glass-ceramic substrate and various cooking articles can introduce additional variations in the temperature measurements. Accordingly, an indirect measurement from one or more NTC is not a sufficient approximation of the cooking article temperature, necessitating a thermal model to estimate the cooking article temperature. The parameters of the thermal model vary based on the cooking article and temperature setpoint, leading to inaccuracies in temperature measurement and control of power input.

While the use of infrared sensors can overcome some limitations of other temperature detection systems, it has been discovered that self-heating within induction cooktops can affect the accuracy of infrared temperature detection, particularly through the glass-ceramic substrate. Notably, typical implementations of glass-ceramic substrates use a material that is only partially transparent so as to obscure the internal components of the induction cooktop (including the induction heating coils). In this manner, when the cooking article is heated, some of the heat from the cooking article is transferred into the glass-ceramic substrate on which it rests. An infrared sensor directed at the cooking article through the glass-ceramic substrate will detect some of this heating because the partial opacity imparts a level of emissivity to the material. Specifically, the heated glass-ceramic substrate will emit infrared radiation that is detected by the infrared sensor in addition to the infrared radiation emitted by the cooking article that is also detected by the infrared sensor. Accordingly, further improvements are desired.

### SUMMARY OF THE DISCLOSURE

According to one aspect of the present disclosure, an induction cooktop includes a glass-ceramic substrate defining a cooking surface and an underside opposite the cooking surface and an induction heating coil positioned beneath the underside of the cooking surface. The induction cooktop further includes an infrared sensor directed toward the underside of the glass-ceramic substrate and outputting a first temperature reading of the glass-ceramic substrate during heating of a cooking article positioned on the cooking surface using the induction heating coil and a far-infrared sensor directed through the glass-ceramic substrate and outputting a second temperature reading of the cooking article and the glass-ceramic substrate. A controller determines a temperature of the cooking article using the first temperature reading from the infrared sensor and the second temperature reading from the far-infrared sensor.

According to another aspect of the present disclosure, a method for determining the temperature of a cooking article positioned on a cooking surface of a glass-ceramic substrate during inductive heating of the cooking article includes receiving a first temperature reading of the glass-ceramic substrate during heating of the cooking article from an infrared sensor directed toward an underside of the glass-ceramic substrate, receiving a second temperature reading of the cooking article and the glass-ceramic substrate from a far-infrared sensor directed through the glass-ceramic substrate, and processing the first and second temperature readings to use the second temperature reading to account for heating of the glass-ceramic substrate by the heating of the cooking article indicated in the second temperature reading.

According to yet another aspect of the present disclosure, an induction cooktop includes a glass-ceramic substrate defining a cooking surface and an underside opposite the cooking surface, the glass-ceramic substrate having an outer portion of a partially-opaque material and an inner portion surrounded by the outer portion and of a transparent material. An induction heating coil is positioned beneath the underside of the cooking surface with a central open area of the induction heating coil aligned with the inner portion of the glass-ceramic substrate. The induction cooktop further includes an infrared sensor positioned within the central open area of the induction heating coil, directed through the inner portion of the glass-ceramic substrate, and outputting a temperature reading of the cooking article and the glass-ceramic substrate.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is perspective view of an induction cooktop useable to heat one or more cooking articles according to an aspect of the disclosure;

FIG. 2 is a depiction of an interior of the induction cooktop, including a plurality of induction heating coils and corresponding pairs of temperature sensors;

FIG. 3 is a graphical representation of the effects of self-heating of the induction cooktop on a temperature measurement for the cooking article;

FIG. 4 is a cross-sectional schematic view of the use of an infrared and a far-infrared sensor to determine the temperature of the cooking article that accounts for self-heating within the induction cooktop;

FIG. 5 is a graphical representation of the temperature measurement for the cooking article that accounts for the effects of self-heating of the induction cooktop;

FIG. 6 is a bottom-perspective view of a cooking article with a coating of a known emissivity for use with the induction cooktop; and

FIG. 7 is a top view of an induction cooktop with transparent inner portions in a glass-ceramic substrate.

The components in the figures are not necessarily to scale, emphasis instead being placed upon illustrating the principles described herein.

### DETAILED DESCRIPTION

The present illustrated embodiments reside primarily in combinations of method steps and apparatus components related to an induction cooktop. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

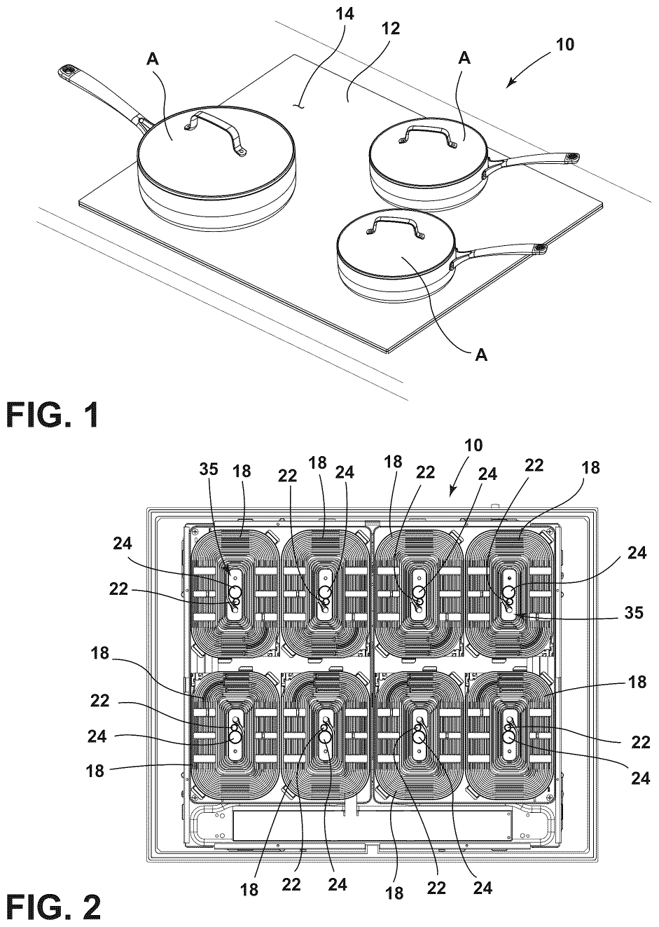

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Referring to FIGS. 1-5, reference numeral 10 generally designates an induction cooktop. The induction cooktop 10 includes a glass-ceramic substrate 12 defining a cooking surface 14 and an underside 16 opposite the cooking surface 14. An induction-heating coil 18 is positioned beneath the underside 16 of the cooking surface 14. The induction cooktop 10 further includes an infrared sensor 20 directed toward the underside 16 of the glass-ceramic substrate 12 and outputting a first temperature reading 22 of the glass-ceramic substrate 12 during heating of a cooking article A positioned on the cooking surface 14 using the induction heating coil 18 and a far-infrared sensor 24 directed through the glass-ceramic substrate 12 and outputting a second temperature reading 26 of the cooking article A and the glass-ceramic substrate 12. A controller 28 determines a temperature of the cooking article A using the first temperature reading 22 from the infrared sensor 20 and the second temperature reading 26 from the far-infrared sensor 24.

Referring specifically to FIGS. 1 and 2, an example of the induction cooktop 10 with which incorporates the infrared and far-infrared sensors 20 and 24, as described herein, can include a number of power-delivery induction coils 18a-18h in an array below the glass-ceramic substrate 12. The glass ceramic substrate 12 can be of any of a number of specific compositions generally used for closed, electric cooktops and for induction cooktops, in particular. The cooktop 10 according to the present disclosure can be a stand-alone unit (e.g., a cooking hob appliance) or included with an oven (such as a conventionally-heated electric oven) in a range appliance. In any such arrangement, the cooktop 10 can be useable to detect the presence of a cooking article, such as the cooking articles A₁, A₂, and A₃ shown in FIG. 1, when resting on the cooking surface 14 of the glass ceramic substrate 12.

In a particular aspect, the controller 28, described herein as determining the temperature of the cooking article A using the first temperature reading 22 from the infrared sensor 20 and the second temperature reading 26 from the far-infrared sensor 24, can be a microprocessor executing routines stored in memory associated therewith. In further implementations, the controller 28 can be an application-specific integrated circuit (“ASIC”), system-on-chip, or other known devices and architectures. The controller 28 can be a microprocessor configured for controlling operation of the induction cooktop 10, including operation of the induction heating coils 18, or can be specifically dedicated to the use with the infrared and far-infrared sensors 20 and 24 in a temperature detection system embedded within the induction cooktop 10.

As can be appreciated, the example induction cooktop 10, as with induction cooktops in general, lacks an actual heat source beneath the glass-ceramic substrate 12, which in theory makes such cooking appliances useable with temperature sensors to measure the actual heating effect achieved by the use of one or more of the inductive heating coils 18 in connection with a cooking article A. Further, the precise and responsive control of cooking article A heating using an induction cooktop 10, such as the depicted induction cooktop 10 makes it possible to achieve a desired temperature in a cooking article, including by initial high levels of heating to decrease the time needed to reach a selected temperature. It has been discovered, however, that, even in the absence of an internal heat source, the precise measurement of the temperature of a cooking article can be difficult, leaving some of the benefits of inductive heating not fully realized. In particular, several above-described temperature detection devices have various limitations. While the use of infrared sensors 20 can overcome some limitations of other temperature detection systems, it has been discovered that self-heating within induction cooktop 10 can affect the accuracy of infrared temperature detection, particularly through the glass-ceramic substrate 12. Notably, typical implementations of the glass-ceramic substrate 12 use a material that is only partially transparent so as to obscure the internal components of the induction cooktop 10 (including the induction heating coils 18). In this manner, when the cooking article A is heated, some of the heat from the cooking article A is transferred into the glass-ceramic substrate 12 on which it rests. An infrared sensor 20 directed at the cooking article A through the glass-ceramic substrate 12 will detect some of this heating because the partial opacity (e.g. transmitting between 30% and 60% of impinging visible light therethrough) imparts a level of emissivity to the material. Specifically, the heated glass-ceramic substrate 12 will emit infrared radiation that is detected by the infrared sensor 20 in addition to the infrared radiation emitted by the cooking article A that is also detected by the infrared sensor 20.

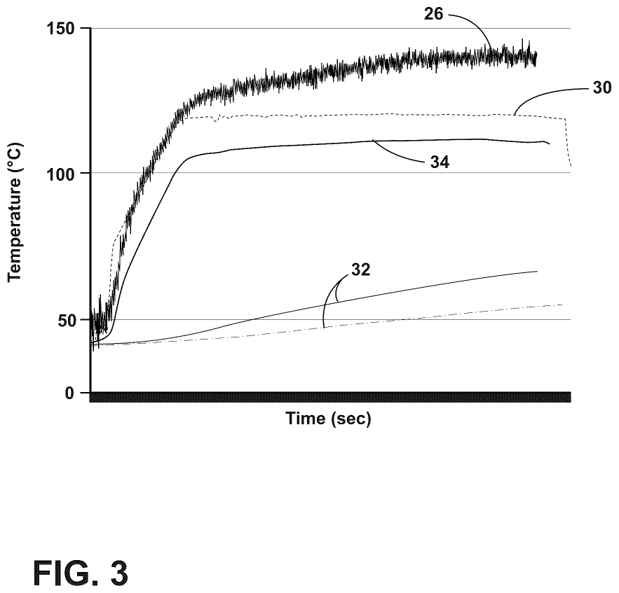

As shown in FIG. 3, during heating of a cooking article A on cooking surface 14 using one or more induction heating coils 18 at a predetermined level, the temperature reading 22 from the infrared sensor 20, as calculated by the controller 28 based on the infrared radiation detected by the infrared sensor 20, will continue to rise over time. This is true, even when an actual temperature measurement 30, including from a thermistor placed in the cooking article A, an external infrared sensor 20 directed only at the cooking article A (i.e., for test purposes), remains steady at a level corresponding with the power delivery after initial heating. As can further be seen, the increase in the temperature reading 22 correlates with continued or lagging increases in an ambient temperature 32 and a temperature 34 of the glass-ceramic substrate 12. By this, it can be seen that sole reliance on the infrared sensor 20 for control of the induction heating coils 18 corresponding with the cooking article A for heating thereof may result in inaccurate control or unintended behavior (such as unnecessary heat-cycling). Again, at least because the glass-ceramic substrate 12 is not completely transparent, the temperature measured by the infrared sensor 20 is influenced by the temperature of the portion of the glass-ceramic substrate 12 that is beneath the cooking article A. Because the glass-ceramic substrate 12 temperature 34 increases due to heat dissipation from the cooking article A, and because the slow dissipation of heat results introduces attenuation and time delays between the temperature of the glass-ceramic substrate 12 and the temperature of the bottom surface of the cooking article A, the temperature measured by the infrared sensor 20 may not accurately reflect the temperature of the cooking article A.

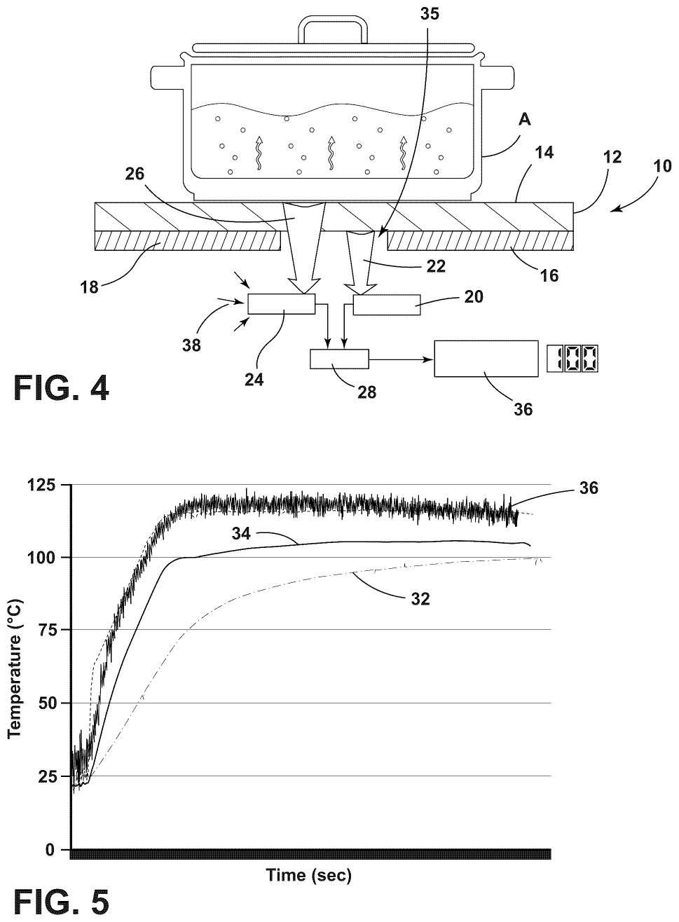

With reference to FIG. 4, the present induction cooktop 10 provides two different sensors that are positioned below the glass-ceramic substrate 12, in advantageous locations, to provide more accurate temperature readings of the bottoms of cooking articles A positioned over the induction heating coils 18 or within the cooking zones of the cooktop 10. The above-mentioned far-infrared sensor 24 is positioned beneath the glass-ceramic substrate 12 in addition to the infrared sensor 20. More particularly, both the infrared sensor 20 and the far infrared sensor 24 can be positioned beneath the glass-ceramic substrate 12 and within an open interior 35 of each induction heating coil 18, as this location provides a clear view to and through the glass-ceramic substrate 12 and coincides with common ideal placement of cooking articles A for heating. In this manner, the far-infrared sensor 24 is tuned to detect and measure wavelengths that are transmitted through the ceramic-glass substrate 12. In various examples, the infrared sensor 20 and far-infrared sensor 24 can be different sensors that are each specifically configured by structure to detect radiation within the near- and mid-infrared ranges and the far-infrared range, respectively, or the infrared sensor 20 and far-infrared sensor may have generally the same structure with different internal detection limits or tuning or used differently by controller 28 to take readings within the desired wavelength ranges. In a more specific example the infrared sensor 20 can be a “digital plug play infrared thermometer”, model number MLX90614, available from Melexis N.V. of West-Flanders, Belgium, and the far-infra red sensor 24 can be a different “digital plug play infrared thermometer”, model number MLX90617, available from Melexis N.V.. In this or further examples, the infrared sensor 20 can be configured to detect electromagnetic radiation in a wavelength range of between 750 nm and 3000 nm, while the far-infrared sensor can be configured to detect electromagnetic radiation in a wavelength range between 3,000 nm and 10,000 nm (1 mm). The equipment and ranges listed herein are exemplary only can be selected or adjusted depending, for example, on the specific configuration and requirements of the cooktop 10.

In general, the controller 28 determines a temperature 36 of the cooking article A using the reading 26 from the far-infrared sensor 24 and the reading 22 from the infrared sensor 20. As discussed above, the reading 26 from the far-infrared sensor 24 generally indicates the cooking article A temperature 34 but is affected by the temperature 34 of the glass-ceramic substrate 12 as well as the ambient temperature 32. The glass-ceramic substrate 12 temperature 34 is measured with the infrared sensor 20 by configuring the infrared sensor 20 to not “look” through the material of the glass-ceramic substrate 12, by one or a combination of its positon and orientation, as well as the particular range of wavelengths that it is tuned to detect. The far-infrared sensor 24 is positioned and otherwise configured to detect wavelengths transmitted through the glass-ceramic substrate 12 and to, accordingly “look” at the bottom of the cooking article A.

The controller 28 uses the reading 22 from the infrared sensor 20 to compensate for self-heating of the glass-ceramic substrate 12 in the final determination of the cooking article A temperature 36. In a general aspect, this may be achieved by subtracting the effect of the self-heating of the glass-ceramic substrate 12 from the reading 26 from the far-infrared sensor 24. Notably, this may not be achieved by directly subtracting the temperature 34 of the glass-ceramic substrate 12 from the temperature 34 indicated by the far-infrared sensor 24, as the tuning of the sensors leads the emissivity of the glass-ceramic substrate 12 to affect the different temperature readings 22 and 26 in different ways, as discussed further below. In general, the glass-ceramic substrate 12, by being of a partially transparent material, causes the temperature reading 26 output by the far-infrared sensor 24 to be of the cooking article A in some combination with (or otherwise affected by) the glass-ceramic substrate 12, due to the partially-transparent material, emitting infrared radiation during heating thereof. In this manner, the controller 28 can be said to determine the temperature 36 of the cooking article A by using the temperature reading 22 to account for heating of the glass-ceramic substrate 12 by the heating of the cooking article A positioned on the cooking surface 14 using the induction heating coil 18, indicated in the second temperature reading 26.

In a further aspect, the determination of the cooking article A temperature 36 uses the reading 22 from the infrared sensor 20, the reading 26 from the far-infrared sensor 24, and the ambient temperature 32 surrounding the far-infrared sensor 24 to more completely compensate for self-heating within the induction cooktop 10. This is due to the fact that, as discussed above with respect to FIG. 4, the heating of the ambient environment surrounding the infrared sensor 20 and the far-infrared sensor 24 can further impact the determination of the temperature 36 of the cooking article A. In this manner, the induction cooktop 10 can further include an ambient temperature sensor positioned beneath the glass-ceramic substrate 12 and a reading 38 of the ambient environment temperature 32. In this respect, the controller 28 can further determine the temperature 36 of the cooking article A using the ambient temperature reading 38 to account for heating of the ambient environment by the heating of the cooking A using the induction heating coil 18, as it may further be indicated in the reading 26 from the far-infrared sensor 24. The three measurements are used to calculate the temperature of the cooking article A (more specifically, the underside of the cooking article A in connection with the cooking surface 14) by accounting for the corresponding effect of self-heating of the glass ceramic substrate 12 and the ambient environment on the reading 26 from the far infrared sensor 24, as shown in FIG. 5. In one aspect, the ambient temperature 32 reading 38 may be obtained directly from the far-infrared sensor 24 such that the ambient temperature sensor can be considered as incorporated into the structure of the far-infrared sensor 24. In this manner, the ambient temperature sensor may be included within the induction cooktop 10 by selection of an appropriate far-infrared sensor 24 with such capability and/or configuration of the far-infrared sensor 24 in connection with the controller 28 to provide and receive this reading 38. In other implementations, different devices can be used for the ambient temperature sensor, such as negative temperature coefficient “NTC” thermistors or the like.

The controller 28 in receiving all three readings 22, 26, and 38 in the implementation of the induction cooktop 10 shown in FIG. 4, can, in one example, implement the following formula to derive the temperature 36 of the cooking article A:

$${T}_{A} = \sqrt[4]{\frac{{V}_{meas} - {c}_{1} {T}_{glass}^{4} - {c}_{2} {T}_{glass}^{4} {T}_{ambient}^{4} + {c}_{3} {T}_{ambient}^{4}}{( Tr + R ) {ε}_{A}}} ,$$

where:

T_{A} is the determined temperature 36 of the cooking article A;

Vₘₑₐₛ is the measured voltage from the far infrared sensor 24;

c₁, c₂, and c₃ are correction factors for emissivity, transmissivity, and reflectance, respectively, of the glass-ceramic substrate 12;

T_{glass} is the temperature of the glass-ceramic substrate 12, as measured by the infrared sensor 20;

T_{ambient} is the ambient temperature 38 within the cooktop 10, as measured by the ambient temperature sensor 32;

Tᵣ and R are correction factors for the transmissivity and reflectance, respectively, of the glass-ceramic substrate 12; and

ϵ_{A} is the emissivity of the cooking article A.

In general, the equation relates the signal received from the far infrared sensor 24 to the temperature of the cooking article A, while using the reading from the infrared sensor 20 to account for the effect of self-heating of the glass-ceramic substrate 12 on the reading of the far-infrared sensor 24 and to account for an increase in the internal temperature of the infrared sensor 20 and far-infrared sensor 24, which is impacted by both self-heating and the ambient temperature 38, as all of these will affect the temperature measurement received from the infrared 20 and far-infrared 24 sensors. As can be appreciated, the ambient temperature 38 has a direct effect on the reading obtained from the far-infrared sensor 24 and the infrared sensor 20. The particular amount to which the controller 28 accounts for the effect of self-heating of the glass-ceramic substrate 12 on the reading of the far-infrared sensor 24, as well as on the reading from the infrared sensor 20 will vary based on the tuning of the sensors 20 and 24, as well as on the particular material composition of the glass ceramic substrate 12. Because these factors are generally known, the controller 28 can compensate appropriately based on the above factors. Due to the different nature in the measurements taken by the far-infrared sensor 24 (through the substrate 12) and the infrared sensor 10 (of the substrate 12), different factors are used. As shown above, the factors c₁, c₂, and c₃ are correction factors for emissivity, transmissivity, and reflectance, respectively, of the glass-ceramic substrate 12 on the reading from the infrared sensor. The factors Tᵣ and R are correction factors for the transmissivity and reflectance, respectively, of the glass-ceramic substrate 12 on the reading of the far-infrared sensor 24.

Using the above equation, a combination of the reading 38 of the ambient temperature 32 and the reading 22 from the infrared sensor 20 can be used to indicate the temperature 34 of the glass-ceramic substrate 12. It is to be appreciated that the equation and related description are given by way of example only and that similar principles can be used to obtain the desired result using other equations and/or processes. As can further be appreciated, the above-described compensation for self-heating of the glass-ceramic substrate 12 requires values for the emissivity and transmissivity of the material comprising the glass-ceramic substrate 12 and for the emissivity of the cooking article A. Because the glass-ceramic substrate 12 is fixed and provided by the manufacturer, the emissivity and transmissivity of the glass-ceramic substrate 12 can be known and stored in memory associated with the controller 28. Because, however, the cooking article A for which the temperature 36 is being measured is intended to be interchangeable, the emissivity of the cooking article A may vary and may not be precisely known. In this manner, there are different ways to provide the cooking article A emissivity to the controller 28 for use in determining the cooking article A temperature 36. In one respect, even though the material composition, surface finish, and optional coatings will vary among different cooking articles A, the general range of emissivity for such articles, particularly ones that are compatible with inductive heating, is known and may be relatively small, compared to the emissivity range for materials in general. Additionally, because the actual effect on the emissivity of the cooking article A on the temperature 36 determination is smaller than other factors, this value may be set as an average of known emissivities of compatible cooking articles. In other arrangements, the controller 28 may determine a closer estimate of the emissivity of the cooking article A during a calibration process carried out during initial use of the cooking article A with the induction cooktop 10. As a still further addition or in the alternative, the controller 28 may ask the user (including during the first use of the cooking article A) the material and/or other characteristics of the cooking article A to provide a closer estimate of emissivity, which can be, for example, stored in memory in a profile of the cooking article A that can be retrieved for later use.

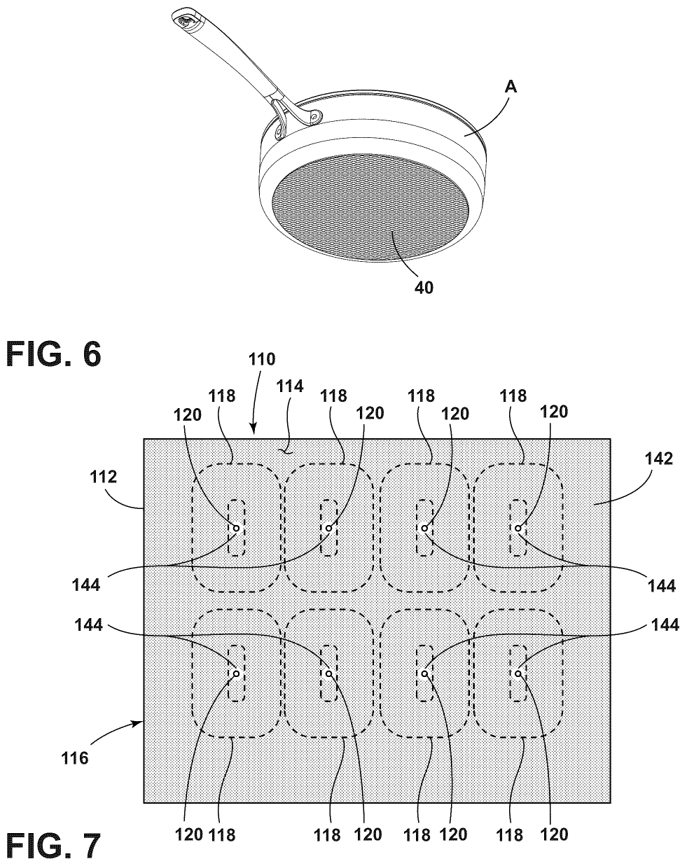

In a further aspect, shown in FIG. 6, the cooking article A may include a coating 40 of a specified emissivity that can be stored in memory or otherwise known to the controller 28. In various respects, such a coating 40 can be used by the manufacturer in developing optimized cookware to be used with the induction cooktop 10 and/or may be specified to others for the manufacture of similar cookware configured for utilization of advanced features of the induction cooktop 10. Additionally, the coating 40 may be fabricated and sold in a manner that can be installed on an existing cooking article A by the user (e.g., a film or sticker). By using a reflective material with a known emissivity on the bottom surface of the cooking article A, the number of unknown parameters required for the temperature 36 calculation is reduced to the emissivity and transmissivity of the glass-ceramic substrate 12, which, again, may be known.

In one example of utilization of the determined temperature 36 of the cooking article A, the controller 28 can receive an entry from a user for heating of the cooking article A to a specified temperature. The controller 28 can then heat the cooking article A, when positioned on the cooking surface 14, using at least one induction heating coil 18 beneath the cooking article A to bring the cooking article A to the set temperature. The improved determination of the cooking article A temperature 36 can allow the controller 28 to more accurately control this heating, which can be completed according to at least one of a time interval and a power level of the induction heating coil 18 such that the temperature 36 of the cooking article A reaches the specified temperature in a faster and more accurate manner. In general, this process may allow consumers to control the temperature of utilized cooking articles A, leading to more consistent and better cooking results and may minimize user mistakes from setting power level instead of temperature. It may also give consumers more control over the cooking process, allowing for more customization and precision in recipes and may simplify the user interaction with the induction cooktop 10 by removing the need to adjust power levels to implicitly achieve a desired temperature, as the process may allow the controller 28 to start at high power level that can be lowered in anticipation of reaching and maintaining the desired temperature more accurately than a user can achieve.

In an additional aspect, the controller 28 may execute a calibration process during initial use of the cooking article A with the induction cooktop 10, as mentioned above. In one implementation, the calibration process may include determining a thermal response of the cooking article A by inductive coupling with the induction heating coil 18. The thermal response of the cooking article A can be determined using the temperature 36 of the cooking article A output by the controller 28, as discussed herein, which can improve the thermal profile model built by the controller 28 in the calibration process.

According to yet another aspect of the disclosure, a method for determining the temperature 36 of a cooking article A positioned on the cooking surface 14 of a glass-ceramic substrate 12 during inductive heating of the cooking article A includes receiving a reading 22 indicating the temperature 34 of the glass-ceramic substrate 12, during heating of the cooking article A, from the infrared sensor 20 directed toward the underside 16 of the glass-ceramic substrate 12 and receiving the reading 26 from the far-infrared sensor 24. Again, the far-infrared sensor 24 is directed through the glass-ceramic substrate 12 to the cooking article A and, accordingly, the reading 26 indicates some combination of the cooking article A temperature 36 and the glass-ceramic substrate 12 temperature 34. In this manner, the method includes processing the readings 22 and 26 from the infrared sensor 20 and the far-infrared sensor 24, in particular by using the reading 22 from the infrared sensor 20 to account for heating of the glass-ceramic substrate 12 during heating of the cooking article A that is indicated in the reading 26 from the far-infrared sensor 24. The method may further include receiving the additional reading 38 of an ambient environment temperature 32 in an area surrounding the infrared sensor 20 and the far-infrared sensor 24 from an ambient temperature sensor (that in the present example is realized in the far-infrared sensor 24). In this aspect, the processing step may further use reading 38 of the ambient temperature 32 to account for heating of the ambient environment that occurs during heating of the cooking article A that is further indicated in the reading 26 from the far-infrared sensor 24. Further aspects of the method are to be understood based on the processes described above as being executed by the controller 28 and/or use of the induction cooktop 10.

In a further aspect of the disclosure, shown in FIG. 7, the effect of a partially-opaque material comprising the glass-ceramic substrate 112 can be mitigated by including fully transparent (e.g., at least 95% transmissivity) areas within the glass ceramic substrate 112, through which a measurement of the temperature of the cooking article A can be measured. In particular, an induction cooktop 110 includes a glass-ceramic substrate 112 defining a cooking surface 114 and an underside 116 opposite the cooking surface 114. The glass-ceramic substrate 112 has an outer portion 142 (or primary portion) of a partially-opaque material (e.g. less than 90% or less than about 60% transmissivity), as discussed above to visually obscure the induction heating coils 118 and/or other internal components of the cooktop 110. The glass-ceramic substrate 112 further includes inner portions 144 surrounded by the outer portion 142 and being of a transparent material. In various aspects, the outer portion 142 may be made at least partially opaque by printing a backing layer on an otherwise transparent material, or by the particular material composition. In this manner, the inner portions 144 can be made transparent by removing or not applying the backing layer in the desired areas for the inner portions 144 or by molding in or otherwise inserting a glass-ceramic material of generally the same composition as the outer portion 142, but lacking the materials used to make the outer portion 142 at least partially opaque.

The induction heating coils 118 are positioned beneath the underside 116 of the cooking surface 114 with a central open area 135 of each induction heating coil 118 aligned with the respective inner portions 144 of the glass-ceramic substrate 112. The induction cooktop 110 further includes infrared sensors 120 positioned within the central open areas 135 of the induction heating coils 118 and directed through the inner portions 144 of the glass-ceramic substrate 112, and outputting a reading 122 corresponding with the temperature of the cooking article A directly, without any significant effect of self-heating of the glass-ceramic substrate 112, as the glass-ceramic substrate 112 has little-to-no detectable emissivity. By making the inner portions 144 of the glass-ceramic substrate 112 transparent, the infrared sensor 120 can see directly through the glass-ceramic substrate 112, which can provide an acceptably accurate temperature measurement without the use of the above-described far-infra red sensor 24.

The invention disclosed herein is further summarized in the following paragraphs and is further characterized by combinations of any and all of the various aspects described therein.

According to another aspect of the present disclosure, an induction cooktop includes a glass-ceramic substrate defining a cooking surface and an underside opposite the cooking surface and an induction heating coil positioned beneath the underside of the cooking surface. The induction cooktop further includes an infrared sensor directed toward the underside of the glass-ceramic substrate and outputting a first temperature reading of the glass-ceramic substrate during heating of a cooking article positioned on the cooking surface using the induction heating coil and a far-infrared sensor directed through the glass-ceramic substrate and outputting a second temperature reading of the cooking article and the glass-ceramic substrate. A controller determines a temperature of the cooking article using the first temperature reading from the infrared sensor and the second temperature reading from the far-infrared sensor.

The controller may determine the temperature of the cooking article by using the second temperature reading to account for heating of the glass-ceramic substrate by the heating of the cooking article positioned on the cooking surface using the induction heating coil indicated in the second temperature reading.

The induction cooktop can further include an ambient temperature sensor positioned on the underside of the glass-ceramic substrate and outputting a third temperature reading of the ambient environment surrounding the infrared sensor and the far-infrared sensor, and the controller may further determine the temperature of the cooking article using the third temperature reading to account for heating of the ambient environment by the heating of the cooking article positioned on the cooking surface using the induction heating coil further indicated in the second temperature reading.

The ambient temperature sensor can be incorporated into a structure of the far-infrared sensor.

The glass-ceramic substrate can be of a partially transparent material, and the second temperature reading output by the far-infrared sensor can be of the cooking article and the glass-ceramic substrate, due to the partially transparent material, emits infrared radiation during heating thereof.

The controller can include information stored in a memory regarding a known emissivity of the glass-ceramic substrate, the known emissivity of the glass-ceramic substrate being used to obtain the first temperature reading and the second temperature reading using the infrared sensor and the far-infrared sensor.

The controller can include information stored in a memory regarding a known emissivity of the cooking article, the known emissivity of the cooking article being used to obtain the second temperature reading using the far-infrared sensor.

The known emissivity of the cooking article can be an estimated emissivity within a known range of emissivity for a selection of cooking article types useable with the induction cooktop for inductive heating.

The controller may determine the known emissivity of the cooking article during a calibration process carried out during initial use of the cooking article with the induction cooktop.

The cooking article may include a coating of a specified emissivity corresponding with the known emissivity stored in the memory.

The controller may further receive an entry from a user for heating of the cooking article to a specified temperature and may heat the cooking article positioned on the cooking surface using the induction heating coil according to at least one of a time and a power level of the induction heating coil such that the temperature of the cooking article, determined using the first temperature reading from the infrared sensor and the second temperature reading from the far-infrared sensor, reaches the specified temperature.

The controller may execute a calibration process during initial use of the cooking article with the induction cooktop, which may include determining a thermal response of the cooking article by inductive coupling with the induction heating coil, and the thermal response can be determined using the temperature of the cooking article determined using the first temperature reading from the infrared sensor and the second temperature reading from the far-infrared sensor.

According to yet another aspect, a method for determining the temperature of a cooking article positioned on a cooking surface of a glass-ceramic substrate during inductive heating of the cooking article includes receiving a first temperature reading of the glass-ceramic substrate during heating of the cooking article from an infrared sensor directed toward an underside of the glass-ceramic substrate, receiving a second temperature reading of the cooking article and the glass-ceramic substrate from a far-infrared sensor directed through the glass-ceramic substrate, and processing the first and second temperature readings to use the second temperature reading to account for heating of the glass-ceramic substrate by the heating of the cooking article indicated in the second temperature reading.

The method may further include receiving a third temperature reading of an ambient environment surrounding the infrared sensor and the far-infrared sensor from an ambient temperature sensor, and the step of processing may further uses the third temperature reading to account for heating of the ambient environment by the heating of the cooking article further indicated in the second temperature reading.

The method may further include retrieving stored information regarding a known emissivity of the glass-ceramic substrate, the known emissivity of the glass-ceramic substrate being used to derive a temperature of the glass-ceramic substrate from the first temperature reading received from infrared sensor.

The method may further include retrieving stored information regarding a known emissivity of the cooking article, the known emissivity of the cooking article being used to derive a temperature of the cooking article and the glass-ceramic substrate from the second temperature reading received from the far-infrared sensor.

The known emissivity of the cooking article can be an estimated emissivity within a known range of emissivity for a selection of cooking article types useable with the induction cooktop for inductive heating.

The method may further include determining the known emissivity of the cooking article during a calibration process carried out during initial use of the cooking article with the induction cooktop.

The cooking article can includes a coating of a specified emissivity corresponding with the known emissivity in the retrieved information.

According to yet another aspect, an induction cooktop includes a glass-ceramic substrate defining a cooking surface and an underside opposite the cooking surface, the glass-ceramic substrate having an outer portion of a partially-opaque material and an inner portion surrounded by the outer portion and of a transparent material. An induction heating coil is positioned beneath the underside of the cooking surface with a central open area of the induction heating coil aligned with the inner portion of the glass-ceramic substrate. The induction cooktop further includes an infrared sensor positioned within the central open area of the induction heating coil, directed through the inner portion of the glass-ceramic substrate, and outputting a temperature reading of the cooking article.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An induction cooktop, comprising:
a glass-ceramic substrate defining a cooking surface and an underside opposite the cooking surface;
an induction heating coil positioned beneath the underside of the cooking surface;
an infrared sensor, configured for detection of electromagnetic radiation in a wavelength range of between 750 nm and 3000 nm, directed toward the underside of the glass-ceramic substrate and outputting a first temperature reading of the glass-ceramic substrate during heating of a cooking article positioned on the cooking surface using the induction heating coil;
a far-infrared sensor, configured for detection of electromagnetic radiation in a wavelength range of between 3000 nm and 10,000 nm, directed through the glass-ceramic substrate and outputting a second temperature reading of the cooking article and the glass-ceramic substrate; and
a controller determining a temperature of the cooking article using the first temperature reading from the infrared sensor and the second temperature reading from the far-infrared sensor.

2. The induction cooktop of claim 1, wherein the controller determines the temperature of the cooking article by using the first temperature reading to account for heating of the glass-ceramic substrate by the heating of the cooking article positioned on the cooking surface using the induction heating coil, indicated in the second temperature reading.

3. The induction cooktop of claim 2, further including an ambient temperature sensor positioned on the underside of the glass-ceramic substrate and outputting a third temperature reading of an ambient environment surrounding the infrared sensor and the far-infrared sensor, wherein:
the controller further determines the temperature of the cooking article using the third temperature reading to account for heating of the ambient environment by the heating of the cooking article positioned on the cooking surface using the induction heating coil further indicated in the second temperature reading.

4. The induction cooktop of claim 3, wherein the ambient temperature sensor is incorporated into a structure of the far-infrared sensor.

5. The induction cooktop of claim 2, wherein:
the glass-ceramic substrate is of a partially transparent material; and
the second temperature reading output by the far-infrared sensor is of the cooking article and the glass-ceramic substrate due to the partially transparent material emits infrared radiation during heating thereof.

6. The induction cooktop of claim 1, wherein the controller includes information stored in a memory regarding a known emissivity of the glass-ceramic substrate, the known emissivity of the glass-ceramic substrate being used to obtain the first temperature reading and the second temperature reading using the infrared sensor and the far-infrared sensor.

7. The induction cooktop of claim 1, wherein the controller includes information stored in a memory regarding a known emissivity of the cooking article, the known emissivity of the cooking article being used to obtain the second temperature reading using the far-infrared sensor.

8. The induction cooktop of claim 7, wherein the known emissivity of the cooking article is an estimated emissivity within a known range of emissivity for a selection of cooking article types useable with the induction cooktop for inductive heating.

9. The induction cooktop of claim 7, wherein the controller determines the known emissivity of the cooking article during a calibration process carried out during initial use of the cooking article with the induction cooktop.

10. The induction cooktop of claim 7, wherein the cooking article includes a coating of a specified emissivity corresponding with the known emissivity stored in the memory.

11. The induction cooktop of claim 1, wherein the controller further:
receives an entry from a user for heating of the cooking article to a specified temperature; and
heats the cooking article positioned on the cooking surface using the induction heating coil according to at least one of a time and a power level of an induction heating coil such that the temperature of the cooking article, determined using the first temperature reading from the infrared sensor and the second temperature reading from the far-infrared sensor, reaches the specified temperature.

12. The induction cooktop of claim 1, wherein:
the controller executes a calibration process during initial use of the cooking article with the induction cooktop, the calibration process including determining a thermal response of the cooking article by inductive coupling with the induction heating coil; and
the thermal response is determined using the temperature of the cooking article determined using the first temperature reading from the infrared sensor and the second temperature reading from the far-infrared sensor.

13. A method for determining a temperature of a cooking article positioned on a cooking surface of a glass-ceramic substrate included in an induction cooktop during inductive heating of the cooking article, comprising:
receiving a first temperature reading of the glass-ceramic substrate during heating of the cooking article from an infrared sensor directed toward an underside of the glass-ceramic substrate;
receiving a second temperature reading of the cooking article and the glass-ceramic substrate from a far-infrared sensor directed through the glass-ceramic substrate; and
processing the first and second temperature readings to use the second temperature reading to account for heating of the glass-ceramic substrate by the heating of the cooking article indicated in the second temperature reading.

14. The method of claim 13, further including receiving a third temperature reading of an ambient environment surrounding the infrared sensor and the far-infrared sensor from an ambient temperature sensor, wherein the step of processing further uses the third temperature reading to account for heating of the ambient environment by the heating of the cooking article further indicated in the second temperature reading.

15. The method of claim 13, further including retrieving stored information regarding a known emissivity of the glass-ceramic substrate, the known emissivity of the glass-ceramic substrate being used to derive a temperature of the glass-ceramic substrate from the first temperature reading received from the infrared sensor.

16. The method of claim 13, further including retrieving stored information regarding a known emissivity of the cooking article, the known emissivity of the cooking article being used to derive a temperature of the cooking article and the glass-ceramic substrate from the second temperature reading received from the far-infrared sensor.

17. The method of claim 16, wherein the known emissivity of the cooking article is an estimated emissivity within a known range of emissivity for a selection of cooking article types useable with an induction cooktop for inductive heating.

18. The method of claim 17, further including determining the known emissivity of the cooking article during a calibration process carried out during initial use of the cooking article with the induction cooktop.

19. The method of claim 17, wherein the cooking article includes a coating of a specified emissivity corresponding with the known emissivity in the retrieved information.

20. An induction cooktop, comprising:
a glass-ceramic substrate defining a cooking surface and an underside opposite the cooking surface, the glass-ceramic substrate having an outer portion of a partially-opaque material and an inner portion surrounded by the outer portion and of a transparent material;
an induction heating coil positioned beneath the underside of the cooking surface with a central open area of the induction heating coil aligned with the inner portion of the glass-ceramic substrate;
an infrared sensor positioned within the central open area of the induction heating coil, directed through the inner portion of the glass-ceramic substrate, and outputting a temperature reading of a cooking article.
